(19) United States
(12) Patent Application Publication
(10) Pub. No.: US 2015/0081370 A1
(43) Pub. Date: Mar. 19, 2015

(54) Method and System of Scheduling, Optimizing and Dynamically Updating Appointment Slots in a Booking System

(71) Applicant: Clevest Solutions Inc., Richmond (CA)

(72) Inventors: Pui Wing Arthur Lo, Richmond (CA); Sarah Irene Myles, Vancouver (CA); Don Marquardt, Vancouver (CA); Andrew David Janzen, White Rock (CA); Chun Kit Howu, Richmond (CA); Malcolm Grant McDonald, Vancouver (CA)

(73) Assignee: Clevest Solutions Inc., Richmond (CA)

(21) Appl. No.: 14/027,050

(22) Filed: Sep. 13, 2013

(51) Int. Cl. G06Q 10/10

(52) U.S. Cl. CPC G06Q 10/1095
USPC 705/7.19

(57) ABSTRACT

A computer-implemented method for a dynamic computer-based appointment slot booking comprises a plurality of steps wherein appointment slots (and their attributes) in a locked database are entangled via one or more virtual umbilical cords in a manner analogous to the formation of quantum systems, in such a way, the entangled appointment slots comprise a system carrying a character of “wholeness” and wherein the database so formed is unlocked (made available for new appointment selection and entry), said act of booking a new appointment i) creates consequences to the entangled appointment slots (and their attributes) ii) reflects the “wholeness” of the quantum system.

### FIELD OF INVENTION

The present invention relates to methods and systems that assist the offering and booking of appointments provided by one or more service populations to efficiently allocate and schedule limited resources.

### BACKGROUND OF THE INVENTION

Management and allocation of limited resources (time, skilled persons, services, space, tools, equipment etc . . . ) is a significant issue for many companies and organizations but is necessary to successfully complete specific project goals and objectives. In project management, resource allocation typically includes the scheduling of activities and the resources required by such activities while taking into consideration both the resource availability and the project time. Resource allocation provides a large number of algorithmic solutions to allocation problems. The demand patterns, however, may undergo permanent or seasonal variations in demand during the life cycle of a process, due to changes in, for example, customer and user requirements. Additionally, there can also be changes in the execution speed of particular processes as process operators become more proficient at their tasks or begin performing new types of tasks. As a consequence, the process moves into a state of sub-optimal performance. Such changes can render the initial resource allocation sub-optimal, which will result in below-par performance of the processes. The actual number of resources required may be higher or lower than the initially allocated number.

The competing interests of customer service and allocation of finite resources is particularly challenging in industries which require scheduling of service appointments and/or scheduled maintenance to customers. Customers prefer prompt and professional service without undue waiting. Companies must be able to utilize their resources in the most “business efficient” manner.

This is particularly true of a utility company, such as one providing electricity, gas, telephone, or cable, and the like, which provides on-site service. Many service related industries, including utilities and telecommunications, require the booking of appointments between customers and workers. In the example of utilities and telecommunications industries, appointments are often necessary to enable workers to access a customer's site to perform particular jobs such as installations and repairs. Booking and managing appointments effectively is a complex task that needs to satisfy the customer's time, location and job requirements, with the availability of appropriate workers.

Utilities must quickly and efficiently respond to ever changing service requests by their customers. Supporting customer service satisfaction is also an objective of managing appointments, which involves reducing customer wait times and finding the earliest available appointments that can meet customer preferences.

Accommodating customer appointment requests is difficult when customers have specific jobs that need to be performed, and are only available at particular days and times. The service company must determine whether there are workers with the necessary skills to perform the particular job at the customer's preferred time. The difficulty in determining available appointments becomes increasingly difficult when companies have numerous workers who possess varying skill sets and each worker performs different jobs. Workers may also be bounded to particular service areas, which limitation adds further complexity to the task of determining available appointments.

Additionally when the service provider schedules a customer request, the provider must determine the time when the service technician will be on-site and provide this information to the customers. Customers' personal schedules are often directly impacted by this time commitment. Additionally, some business customers may alter their business operations based on when the service technician is scheduled to be on site. In such an environment, customer service is directly impacted by the provider's ability to accurately schedule and communicate the time window allocated to the service request.

The service provider, based on experience, must plan the sequence in which the work will be done, and the extent to which resources (workforce members) will be devoted to any particular task. Unforeseen circumstances, such as emergent customer requests and absent employees, may effect this plan with again unforeseen consequences. Such circumstances must be considered by an experienced provider.

The ability for service companies to make bookings quickly and accurately affects customer service, employee utilization and operating costs. Companies must be able to quickly arrange appointments with customers to prevent unnecessary wait times and delays, while also ensuring that sufficiently skilled workers are available for the appointment. Furthermore companies must ensure that there are no over bookings, and reduce appointment gaps that would lead to excessive idle time for employees.

Prior software systems have aimed to assist the appointment booking process. However, when a customer has a set of preferred dates and times, prior systems typically only allow the call taker to submit each of the customer's preferred dates and times one at a time. The call taker would need to determine availability for each of the customer's preferences through a consecutive search. Search results would therefore indicate the availability of only one date and time preference at a time. Prior systems may generate and include a list of alternative dates and times in its search results, however, the alternatives would not necessarily relate to the customer's stated preferences. The process of booking appointments to satisfy customer needs and preferences can thereby be very inefficient and time consuming.

Satisfying job type assignment and area preferences to optimize employee utilization, and supporting workload preferences and worker equality may also be necessary objectives. This requires the ability to control the number of jobs offered by type, date and time, appointment window type and location. Managing the number of appointments that can be offered according to job types and appointment windows involves tremendous complexity. The system must be able to control and calculate the number of potential jobs that workers can perform for each appointment window in each service area. As appointments are booked the system must also be able to determine how other appointment offerings are affected and make accurate changes in real time to the number of potential appointments offered for each appointment window.

The complexity of managing appointment window types can be compounded by the need to account for a multitude of appointment windows that may be defined as All Day, AM/PM, 4-hour and 2-hour appointment windows. Such definitions of appointment windows create a hierarchical relationship that involves the overlapping and imposing of appointment window types onto others. Prior software systems treat appointment window types as buckets of time. The buckets determine the amount of time available according to skill and the particular appointment window type. The buckets, however, lack the ability to account for the number of jobs that are offered.

Prior software systems typically only aggregate and pool the workers' availability according to their primary skill. This limitation is intentionally imposed to avoid the inherent complexity and vast permutations in managing additional secondary and tertiary skills that workers may possess.

Often when an appointment request is received it typically relates to a particular job type, which may require multiple skills. However, prior software systems can only approximate the available time for the appointment due to the limitation of basing appointments only on the primary skill involved. Therefore, the accuracy of the system is questionable due to the fact that much information, including any required secondary and tertiary skills, have not been captured and retained during the appointment availability build process. The exact number of jobs that can be offered, controlled, accounted for, and subsequently tracked cannot be processed or determined.

It is an object of the present invention to obviate or mitigate these disadvantages.

### SUMMARY OF THE INVENTION

The present invention provides computer-implemented methods for a dynamic computer-based appointment slot booking, wherein appointment slots (and their attributes) in a locked database are entangled via one or more virtual umbilical cords in a manner analogous to quantum systems. In such a way, the entangled appointment slots are comprised in a system carrying a character of “wholeness”. When the database so formed is unlocked (made available for new appointment selection and entry), the act of booking a new appointment creates consequences to the entangled appointment slots (and their attributes) reflecting the “wholeness” of a quantum system.

In one aspect, the present invention provides a method for dynamically scheduling and optimizing appointment slots for delivery/conveyance of a finite resource, said slots being stored in a database using a computing device, the computing device having a processor, a memory, and an entanglement application stored in the memory and executable by the processor, the method comprising locking the database for a period of reconciliation and entanglement; deleting expired appointment slots; refreshing existing appointment slots, existing appointment slots attributes and previously saved related information (“refreshed old information”); entering data relating to availability of the finite resource and at least one attribute of the finite resource over time period X (“new information”); creating virtual umbilical cords for new information and recreating virtual umbilical cords for refreshed old information; reconciling refreshed old information and new information via the virtual umbilical cords so formed, thereby triggering a quantum entanglement of refreshed old information (including existing appointment slots) and new information via said virtual umbilical cords (“entangled system over time period X”); unlocking the database, said database then being in a state of availability for new appointment entry over time period X; during time period X, receiving a new request for delivery of the finite resource wherein said request may comprise a plurality of preferences of possible dates and appointment windows; replying to the request with an offer of one or more available appointment slots that satisfy at least one of plurality of preferences of possible dates and appointment windows; and booking said appointment and connecting the appointment to a new appointment slot (“new appointment slot”), wherein said booking impacts and has consequences upon the entangled system over time X.

In another aspect, the present invention provides a computer system directed by a computer program operable to dynamically schedule and optimize appointment slots for delivery/conveyance of a finite resource, said slots being stored in a database, the computer system comprising: a software engine; a storage device operable to store program data; a memory operable to store a computer program; a processor coupled to the storage device and the memory, the processor operable to execute the computer program such that the computer is directed by the computer program to schedule and optimize appointment slots for delivery/conveyance of a finite resource by performing the steps of: locking the database for a period of reconciliation and entanglement; deleting expired appointment slots; refreshing existing appointment slots, existing appointment slots attributes and previously saved related information (“refreshed old information”); entering data relating to availability of the finite resource and at least one attribute of the finite resource over time period X (“new information”); creating virtual umbilical cords for new information and recreating virtual umbilical cords for refreshed old information; reconciling refreshed old information and new information via the virtual umbilical cords so formed, thereby triggering a quantum entanglement of refreshed old information (including existing appointment slots) and new information via said virtual umbilical cords (“entangled system over time period X”); unlocking the database, said database then being in a state of availability for new appointment entry over time period X; during time period X, receiving a new request for delivery of the finite resource wherein said request may comprise a plurality of preferences of possible dates and appointment windows; replying to the request with an offer of one or more available appointment slots that satisfy at least one of plurality of preferences of possible dates and appointment windows; and booking said appointment and connecting the appointment to a new appointment slot (“new appointment slot”), wherein said booking impacts and has consequences upon the entangled system over time X.

In yet another aspect, the present invention provides a non-transitory computer-readable medium having stored thereon computer-readable instructions operable to dynamically schedule and optimize appointment slots for delivery/conveyance of a finite resource, said slots being stored in a database, such that when said instructions are executed by a computing device, it causes the computing device to lock the database for a period of reconciliation and entanglement; delete expired appointment slots; refresh existing appointment slots, existing appointment slots attributes and previously saved related information (“refreshed old information”); enter data relating to availability of the finite resource and at least one attribute of the finite resource over time period X (“new information”); create virtual umbilical cords for new information and recreate virtual umbilical cords for refreshed old information; reconcile refreshed old information and new information via the virtual umbilical cords so formed, thereby triggering a quantum entanglement of refreshed old information (including existing appointment slots) and new information via said virtual umbilical cords (“entangled system over time period X”); unlock the database, said database then being in a state of availability for new appointment entry over time period X; during time period X, receive a new request for delivery of the finite resource wherein said request may comprise a plurality of preferences of possible dates and appointment windows; reply to the request with an offer of one or more available appointment slots that satisfy at least one of plurality of preferences of possible dates and appointment windows; and book said appointment (the booking) and connect the appointment to a new appointment slot (“new appointment slot”), wherein the booking impacts and has consequences upon the entangled system over time X.

In a further aspect of the invention, there is provided a graphical user interface for users to apply the method as described herein.

What is provided herein is an appointment booking system that assists users in managing appointment slots offered and the efficient booking of appointments to satisfy customer needs and preferences, and, of course, employee utilization. Many businesses, such as utilities and telecommunications industries, book appointments with customers to perform numerous types of jobs offered by their workers. Within each day, for example, there are a finite number of appointment slots. Particular resources may be required at different appointment slots. If finite resource is a worker, he/she may possess a specific skill sets and has the potential of performing a variety of job types that involve different amounts of time. With the present invention, appointment booking is considered from a “pool of time”. A request for a new appointment within a specific time within this pool may be contributed to or delivered by one or more workers. At this stage, that is of no import. However, the act of “booking” the appointment slot (irrespective of the entity that does so or the specific worker that will complete the work required) will book to a slot, wherein said slot is from an existing but dynamic database of entangled appointment slots. The booked or committed appointment slot is a committed time, in the future, for the delivery of a finite resource. While there are requirements and attributes of the finite resource to be delivered, the specific identity of the finite resource (for example worker or workers) that will complete the work required is not finally committed. The specific identity of the finite resource that will complete the work may dynamically change between a) time of booking and b) booked appointment slot time based upon a plurality of factors including new appointment slots which are booked and entangled with committed appointment slots in the database and alterations made to appointment slots, resources and attributes by users.

Prior to committing any appointments for a given period of time, the aggregate number of potential jobs that can be performed and offered for booking would be numerous. Once an appointment for a particular job type has been committed, the subsequent number of potential jobs and job types that can be offered would necessarily be reduced. The accurate and immediate calculation of the subsequent number of potential jobs and job types that can be offered is necessary to support effective appointment booking and employee utilization. However, tremendous complexity is involved in the calculation due to the numerous attributes or variables related to the finite resource (for example, the number of workers, varying skill sets, job types, locations, varying time requirements, employee preferences, and job offering constraints, etc. . . . ). A method of entangling appointment slots and attributes associates therewith is provided herein to manage appointment slot bookings efficiently and address the complexity of accurately and quickly determining the available appointment slot offerings for the deliverance/conveyance of all finite resources. In particular, as availability of slots changes, the entire set of “virtually linked” attributes or parameters is updated.

Further, users may observe that once a particular appointment is booked the subsequent state of appointment slots for any number of job types across appointment windows can be affected; however, the user may not be able to easily identify the relationship between the particular appointment booked with the subsequent appointment slots that have been affected. As described further below, the observed effect to appointment slots is similar to observing the effects of quantum entanglement as described in quantum physics. In quantum entanglement a change in the state of one particle would affect the state of another entangled particle (or group of particles), even where the two particles are separated by an arbitrarily large distance. In quantum entanglement the physical connection of the entangled particles cannot be visually observed, but the correlated effect of their entanglement can be measured. Albert Einstein described the characteristic of entangled particles as “spooky action at a distance”¹. Letter from Einstein to Max Born, 3 Ma. 1947; The Born-Einstein Letters; Correspondence between Albert Einstein and Max and Hedwig Born from 1916 to 1955, Walker, N.Y., 1971.

The method presented herein entangles all appointment slots that can be potentially offered by all workers across multiple appointment windows to enable the accurate measurement and immediate change to related appointment slots once any particular appointment has been committed. The numbers of jobs that can be offered by each worker including all relevant attributes and parameters are aggregated and measured in terms of appointment slots. The method of creating appointment slots produce what are termed Entangled Appointments or Quantum Inspired Appointments.

The method presented herein creates entangled appointment slots through the use of what are termed invisible umbilical cords (also called virtual umbilical cords or simply umbilical cords. The method of using umbilical cords to create entangled appointment slots is inspired by a further concept of quantum entanglement described by the renowned theoretical physicist Dr. Michio Kaku who describes the invisible entanglement of electrons as an “invisible umbilical cord”². Brent Baughman (2010). National Public Radio (NPR.org): Scientists Take Quantum Steps Toward Teleportation. Last accessed 15 Aug. 2013

The invention also provides methods for controlling the number of jobs offered by workers according to area, job type and appointment window.

What was needed and is provided by the method and system of the invention is a means to quickly and accurately assist the management and booking of numerous and often changing potential appointment slots.

Other advantages of the present invention will become apparent from the detailed description of the invention and the illustrations provided herein.

### BRIEF DESCRIPTION OF THE DRAWINGS

FIG. 1 illustrates a block diagram of an exemplary computing environment in which the present invention may be implemented according to one preferred embodiment.

FIG. 2 shows an embodiment of a graphical user interface tool according to the invention that enables the configuration of work day shift details.

FIG. 3 illustrates a flow chart for entangling all appointments slots that can be offered for a particular day by all workers.

FIG. 4 illustrates a flow chart for entangling appointments slots for each worker.

FIG. 5 illustrates a user interface for a Job Offering Set Tool for controlling appointment offerings.

FIG. 6 shows a logical Capacity Table that illustrates the results from building entangled appointment slots and the changes to capacities and appointments slots across job types from bookings

FIG. 7 illustrates job offering set configurations that are applied to the logical Capacity Table in FIG. 6.

FIG. 8 illustrates an Appointment Booking Screen in which a user has entered a customer's set of preferred appointment times.

FIG. 9 illustrates a results screen that simultaneously shows all days and appointment windows that satisfy the customer's appointment preferences.

FIG. 10 illustrates an Entity Relationship Diagram for an Entangled Appointments Schema (EAS).

### DETAILED DESCRIPTION OF AN ILLUSTRATIVE EMBODIMENT

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

I Terms

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine. The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or machine or distributed across several devices or machines.

As used herein, the term “data model” is intended to encompass a dataset schema. Moreover, as used herein, the term “entry” is intended to encompass a database instance, as well as database rows, documents, nodes, and edges (in the case of NoSQL databases).

Additionally, the term “schema” is intended to encompass both formal schemas and informal conceptual models of contents of a dataset, including but not limited to conceptual models that aid in describing content and structure in semi-schematized datasets, schema-free datasets, loosely schematized datasets, datasets with rapidly changing schemas, and/or the like.

Where two or more terms or phrases are synonymous (e.g., because of an explicit statement that the terms or phrases are synonymous), instances of one such term/phrase does not mean instances of another such term/phrase must have a different meaning For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. section 1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

Any algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “device” and “computing device” includes any personal digital assistants, Smart phones, other cell phones, tablets and the like.

The term “variation” of an invention means an embodiment of the invention, unless expressly specified otherwise. A reference to “another embodiment” or “another aspect” in describing an embodiment does not imply that the referenced embodiment is mutually exclusive with another embodiment (e.g., an embodiment described before the referenced embodiment), unless expressly specified otherwise.

As used herein, “entanglement” is taken to mean a virtual interconnectedness. It is well known that in quantum physics there is description of a universe which is unbroken and inseparable, in which all parts interpenetrate all others. Things can only be defined or described in their relationship with other things. Quantum entanglement is a phenomenon wherein once two particles have interacted they are forever part of the same system, interacting with one another even at great distances. Each is definable only by its relationship to the other i.e. nothing stands separate unto itself.

The terminology referring to “entanglement” within the scope of the present invention is purposeful. Appointment slots and attributes are entangled via one or more virtual umbilical cords during a time period X in which a database comprises said slots is in a locked state i.e. not accepting of new appointments. One of the most critical attributes is the total number of slots available. Such appointment slots are related by, for example, job codes (JobCode), shifts, areas, appointment window types etc . . .

Wherein the database is in an “unlocked” state, the act and consequence of booking a new appointment slot, in effect, makes a change to the “number of appointment slots”, most often increasing the “number of booked appointments” for the Appointment Slots (or in the system, “ApptJobSlots”). The net effect is that booking may affect the availability (or usually will decrease the number of available appointment slots) of other entangled ‘Appointment Slots’. Also, in a preferred form, when an appointment is booked, there is created in the database a row for table “ApptSlotBooking”—this is simply a store from which “appointment slots” this particular appointment comes, so that eventually if there is a “cancellation”, the system knows how to update in the right place. Further explanation of this is via “600”, the logical Capacity Table, and related information.

As used herein, a wide interpretation should be given to “users” of the method and system. In some systems, users may be customer service agents, tasked with appointment booking for a finite resource. Examples include agents of utility companies, service delivery companies and booking service companies (for example, in transportation, entertainment, delivery of medical services, etc . . . ).

As used herein, a wide interpretation should be given to “finite resource”. In some cases, the finite resource may be workers (for example with specific skill sets) but it also includes a plurality of other products and services.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

In general, an input interface provides an interface for receiving information from the user for entry into user device. Input interface (also called graphical user interface) may use various input technologies including, but not limited to, a keyboard, a pen and touch screen, a mouse, a track ball, a touch screen, a keypad, one or more buttons, etc. to allow the user to enter information into user device or to make selections presented in a user interface displayed on display. The same interface may support both input interface and output interface. For example, a touch screen both allows user input and presents output to the user. User device may have one or more input interfaces that use the same or a different input interface technology. Keyboard, the pen and touch screen, mouse, the track ball, the touch screen, the keypad, the one or more buttons, further may be accessible by user device through a communication interface.

Computer-readable medium is an electronic holding place or storage for information so that the information can be accessed by processor as known to those skilled in the art. Computer-readable medium can include, but is not limited to, any type of random access memory (RAM), any type of read only memory (ROM), any type of flash memory, etc. such as magnetic storage devices (e.g., hard disk, floppy disk, magnetic strips, . . . ), optical discs (e.g., CD, DVD, . . . ), smart cards, flash memory devices, etc. User device may have one or more computer-readable media that use the same or a different memory media technology. User device also may have one or more drives that support the loading of a memory media such as a CD or DVD. Computer-readable medium may provide the electronic storage medium for database that may optionally be stored on user device 201.

Communication interface provides an interface for receiving and transmitting data between devices using various protocols, transmission technologies, and media as known to those skilled in the art. Communication interface may support communication using various transmission media that may be wired or wireless. User device may have one or more communication interfaces that use the same or a different communication interface technology. Data and messages may be transferred between user system and data processing system and/or between another user system of the plurality of user systems using communication interface.

A processor executes instructions as known to those skilled in the art. The instructions may be carried out by a special purpose computer, logic circuits, or hardware circuits. Thus, processor may be implemented in hardware, firmware, or any combination of these methods and/or in combination with software. The term “execution” is the process of running an application or the carrying out of the operation called for by an instruction. The instructions may be written using one or more programming language, scripting language, assembly language, etc. Processor executes an instruction, meaning that it performs/controls the operations called for by that instruction. Processor operably couples with output interface, with input interface, with computer-readable medium, and with communication interface to receive, to send, and to process information. Processor may retrieve a set of instructions from a permanent memory device and copy the instructions in an executable form to a temporary memory device that is generally some form of RAM. User device may include a plurality of processors that use the same or a different processing technology.

Output interface provides an interface for outputting information for review by a user of user device. For example, output interface may include an interface to display, speaker, printer etc. . . . Display may be a thin film transistor display, a light emitting diode display, a liquid crystal display, or any of a variety of different displays known to those skilled in the art. Speaker may be any of a variety of speakers as known to those skilled in the art. Printer may be any of a variety of printers as known to those skilled in the art. User device may have one or more output interfaces that use the same or a different interface technology. Display, speaker, and/or printer further may be accessible by user device through communication interface.

The scheduling tool performs operations associated with scheduling appointments and assigning resources to the scheduled appointments. As used herein, appointments include any appointment made to convey or deliver a finite resource. These include, but are not limited to: utility company worker appointments (often in customer homes), physician appointments, technician appointments, medical procedure appointments, interviews, etc . . .

Some or all of the operations described herein may be embodied in a scheduling application. The operations may be implemented using hardware, firmware, software, or any combination of these methods. A scheduling application may be implemented in software (comprised of computer-readable and/or computer-executable instructions) stored in computer-readable medium and accessible by processor for execution of the instructions that embody the operations of scheduling application. Scheduling application may be written using one or more programming languages, assembly languages, scripting languages, etc. . . . and may be implemented as a plug-in or be otherwise integrated with browser application. Furthermore, scheduling application may be implemented as a Web application executing, for example, at user device and/or server computing device that supports any type of communication protocol. For example, scheduling application may be configured to receive and to send hypertext transport protocol (HTTP) messages along with optional additional data content which may include web pages such as hypertext mark up language (HTML) documents and linked objects from/to server computing device and/or database.

Scheduling application further may provide information or data organized in the form of a website accessible over network. A website may comprise multiple web pages that display a specific set of information and may contain hyperlinks to other web pages with related or additional information. Each web page is identified by a uniform resource locator (URL) that includes the location or address of the computing device that contains the resource to be accessed in addition to the location of the resource on that computing device. The type of file or resource depends on the Internet application protocol. For example, HTTP and HTTP secure (HTTPS) describe a web page to be accessed with a browser application. The file accessed may be a simple text file, an image file, an audio file, a video file, an executable, a common gateway interface application, a Java applet, or any other type of file supported by HTTP.

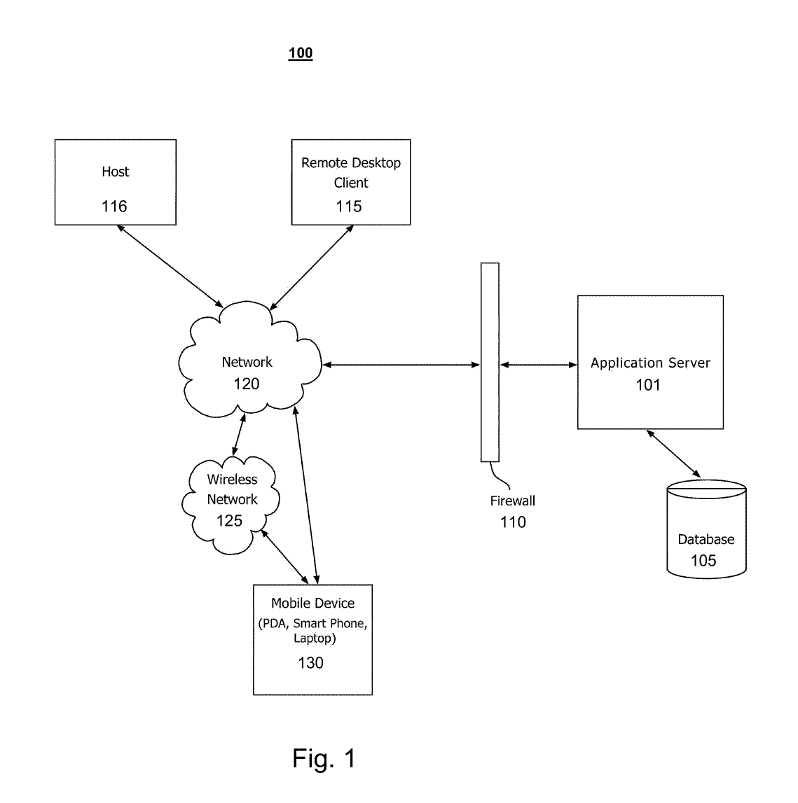

An exemplary computer system is shown as a block diagram in FIG. 1 which is a high-level diagram illustrating an exemplary configuration of a dynamic coordination system. In one arrangement, computing device can be a personal computer or server. In other arrangements, computing device can be a tablet computer, a laptop computer, or a mobile device/Smartphone, though it should be understood that computing device of dynamic coordination system can be practically any computing device capable of embodying the systems and/or methods described herein.

Computing device preferably includes a control circuit which is operatively connected to various hardware and software components that serve to enable operation of the dynamic coordination system. The control circuit is operatively connected to a processor and a memory. Processor serves to execute instructions for software that can be loaded into memory. Processor can be a number of processors, a multi-processor core, or some other type of processor, depending on the particular implementation. Further, processor can be implemented using a number of heterogeneous processor systems in which a main processor is present with secondary processors on a single chip. As another illustrative example, processor can be a symmetric multi-processor system containing multiple processors of the same type.

Preferably, memory and/or storage are accessible by processor, thereby enabling processor to receive and execute instructions stored on memory and/or on storage. Memory can be, for example, a random access memory (RAM) or any other suitable volatile or non-volatile computer readable storage medium. In addition, memory can be fixed or removable. Storage can take various forms, depending on the particular implementation. For example, storage can contain one or more components or devices such as a hard drive, a flash memory, a rewritable optical disk, a rewritable magnetic tape, or some combination of the above. Storage also can be fixed or removable.

At various points during the operation of the method of the invention, one computing device can communicate with one or more remote devices. The remote devices transmit and/or receive data to/from the computing device, thereby preferably initiating maintaining, and/or enhancing the operation of the system, as will be described in greater detail below. It should be understood that remote devices can be in direct communication with first computing device, indirect communication with first computing device, and/or can be communicatively coordinated with computing device, as will be described in greater detail below. While remote device can be practically any device capable of communication with first computing device, in the preferred embodiment remote device is a personal computer, server, handheld/portable computer, Smartphone, personal digital assistant (PDA), tablet computer, and/or any other such computing device that is capable of transmitting and/or receiving data to/from first computing device.

The method and system presented herein is particularly useful in assisting users in managing the offering and booking of appointments for a variety of job types that may be performed by workers during particular shift times and dates. Method steps are as follows:
a) locking the database for a period of reconciliation and entanglement;
b) deleting expired appointment slots;
c) refreshing existing appointment slots, existing appointment slots attributes and previously saved related information (“refreshed old information”);
d) entering data relating to availability of the finite resource and at least one attribute of the finite resource over time period X (“new information”);
e) creating virtual umbilical cords for new information and recreating virtual umbilical cords for refreshed old information;
f) reconciling refreshed old information and new information via the virtual umbilical cords so formed, thereby triggering a quantum entanglement of refreshed old information (including existing appointment slots) and new information via said virtual umbilical cords (“entangled system over time period X”);
g) unlocking the database, said database then being in a state of availability for new appointment entry over time period X;
h) during time period X, receiving a new request for delivery of the finite resource wherein said request may comprise a plurality of preferences of possible dates and appointment windows;
i) replying to the request with an offer of one or more available appointment slots that satisfy at least one of plurality of preferences of possible dates and appointment windows; and
j) booking said appointment and connecting the appointment to a new appointment slot (“new appointment slot”), wherein said booking impacts and has consequences upon the entangled system over time X.

Preferably, a customer requests an appointment for delivery of a finite resource (for example, a worker coming to fix a cable line at his/her house). Customer specifies his/her need for possible appointment times and preferences (for example: Thursday, Friday, only PM and “14-16” 2-hour window (multiple preferences). In accordance with the invention, the system provide a means to search for any appointment slot(s) that would satisfy, for example, Thursday PM, Thurs. 14-16, Fri PM, Fri 14-16 (4 different appointment types with slots). Results may return as follows:
Thursday PM (0 available), Thursday 14-16 (5 available)
Friday PM (2 available), Friday 14-16 (0 available)

Customer service agent (a call taker) then conveys to the customer the availability, and allows the customer to choose, which he/she does: for example Thursday 14-16. Appointment slot for (Thursday 14-16) in accordance with step j) above is booked.

Preferably, the database is subsequently locked at one of: i) any time before and ii) the expiry of time X to enter availability of the finite resource and at least one attribute of the finite resource over time period Y and for a period of reconciliation and entanglement relating to time period Y. Preferably, the finite resource is at least one of a person, a space, a tool, or equipment, most preferably a skilled worker. Preferably, the finite resource is a worker and attributes comprise at least one of: number workers, skill sets, task types, geographic location of tasks, time requirements, and task constraints. Preferably, the attribute comprises specific details of slots, resources and requests.

Preferably, steps a) to j) above are repeated at pre-determined time increments.

Preferably, a method of building new appointment slots comprises
a) constructing at least one virtual umbilical cord (virtual map) relating to each finite resource and attribute thereof;
b) updating at least one virtual umbilical cord relating to each committed appointment slot and attributes thereof;
c) constructing at least one virtual umbilical cord (virtual map) relating to each available appointment slot and attributes thereof.

Preferably, the finite resource is the future availability of one or more workers, working a shift, on a day, to complete a job wherein a shift comprises one or more appointment slots. Preferably, building a new appointment slot comprises the following steps: reconstructing virtual umbilical cords for all previously added, deleted or changed appointment slots in the database for form Reconstructed UmbCords, said Reconstructed UmbCords enabling reconciliation and entanglement of committed appointment slots (and attributes) and new appointments slots (and attributes) and wherein if no previous committed appointment slots are found, new appointment slots, so entangled are added to the database. Preferably, an inventory of appointment slots, committed slots and request for a new appointment are governed by a time dimension provided by day and time capacity tables. Preferably, managing an inventory of appointment slots, committed slots and the new request for an appointment at appointment slot A employ the use of an Appointment Slot Booking Table within an Entangled Appointments Schema. Preferably, umbilical cords for attributes are reconstructed according to information stored in the database according to an Entangled Appointments Schema. Preferably, an SQL statement is employed to access a Entangled Appointments Schema to simultaneously identify the availability of multiple appointment preferences for a set of multiple appointment preferences. Preferably, attributes of the database of appointment slots and resources and committed appointment slots and resources are used to identify openings in slots and resources.

The present invention provides a computer system directed by a computer program operable to dynamically schedule and optimize appointment slots for delivery/conveyance of a finite resource, said slots being stored in a database, the computer system comprising: a software engine; a storage device operable to store program data; a memory operable to store a computer program; a processor coupled to the storage device and the memory, the processor operable to execute the computer program such that the computer is directed by the computer program to schedule and optimize appointment slots for delivery/conveyance of a finite resource by performing the steps of: locking the database for a period of reconciliation and entanglement; deleting expired appointment slots; refreshing existing appointment slots, existing appointment slots attributes and previously saved related information (“refreshed old information”); entering data relating to availability of the finite resource and at least one attribute of the finite resource over time period X (“new information”); creating virtual umbilical cords for new information and recreating virtual umbilical cords for refreshed old information; reconciling refreshed old information and new information via the virtual umbilical cords so formed, thereby triggering a quantum entanglement of refreshed old information (including existing appointment slots) and new information via said virtual umbilical cords (“entangled system over time period X”); unlocking the database, said database then being in a state of availability for new appointment entry over time period X; during time period X, receiving a new request for delivery of the finite resource wherein said request may comprise a plurality of preferences of possible dates and appointment windows; replying to the request with an offer of one or more available appointment slots that satisfy at least one of plurality of preferences of possible dates and appointment windows; and booking said appointment and connecting the appointment to a new appointment slot (“new appointment slot”), wherein said booking impacts and has consequences upon the entangled system over time X.

Preferably, this system comprises a graphical user interface tool providing the means to add, remove, and/or configure appointment slots. Preferably, the graphical user interface tool providing the means to add, remove, and/or configure attribute details.

In further detail, FIG. 1 shows an exemplary computing environment in which the present invention may be implemented. Those skilled in the art will appreciate that the appointment booking system may be implemented with other computer system configurations.

Remote desktop clients 115 and/or host 116 and wireless mobile clients 130 may access application server 101 and database 105, which may be located behind a firewall 100, through wireless network 125 and/or network 120, such as the Internet. Host 116 provides and receives information regarding appointments to and from the application on server 101. Mobile devices 130 include portable computing devices that send and receive messages over wireless network 125, and/or devices that work in a disconnected mode and send and receive information when a network connection is established. Mobile devices are client devices, and include cellular phones, smart phones, PDAs, handheld computers, laptop computers, tablet computers, and the like. Database 105 is used to store information related to appointment offering details, worker information, shift information and job type information and appointment bookings

The appointment booking system presented herein assists users in managing the offering and booking of appointments for a variety of job types that may be performed by workers during particular shift times and dates.

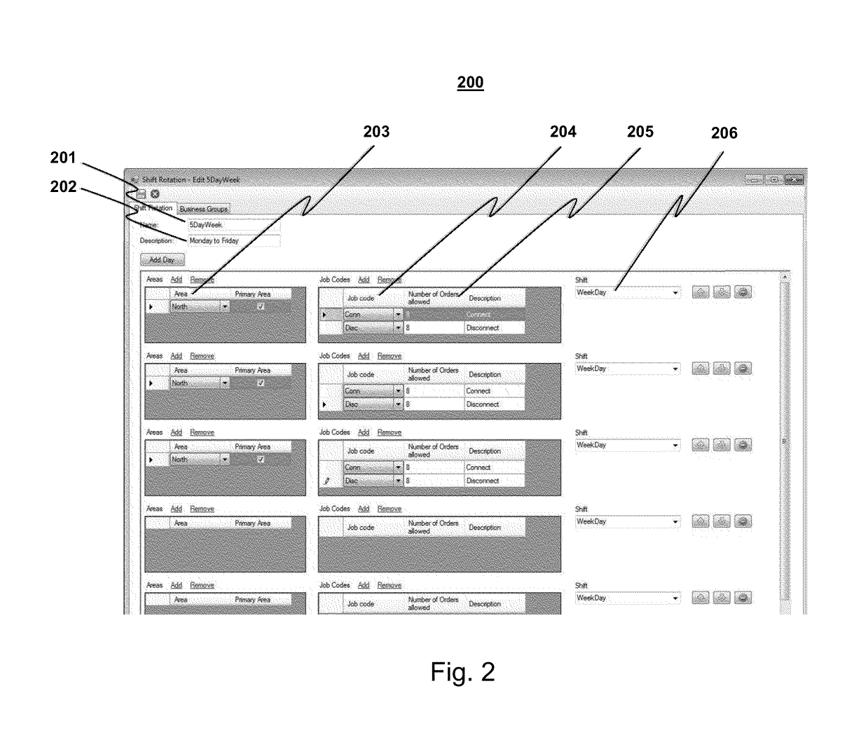

The appointment booking system provides a graphical user interface (GUI) for a Shift Details Input Tool 200 for the configuring of job offering details for particular work days. FIG. 2 illustrates the Shift Details Input Tool 200, which shows details for the configuration of a “SDayWeek” 201 that is described as “Monday to Friday” 202. A user may configure details for each of the five days including the work area 203, the job types to be performed 204, the number of orders allowed 205, and specify the type of shift 206. The Shift Details Input Tool 200 illustrates how each appointment may involve multiple variables including the area in which the job may be offered, the type of job to be performed, the day of the week and the number of jobs that may be performed for that particular day. The system would filter and present a list of workers who have the necessary skills and attributes to perform the particular jobs as defined in the Shift Details Input Tool 200. An administrator would then be able to select and assign only those workers presented by the system to a particular shift to support the offering of service appointments according to the details configured for that day by the Shift Details Input Tool 200.

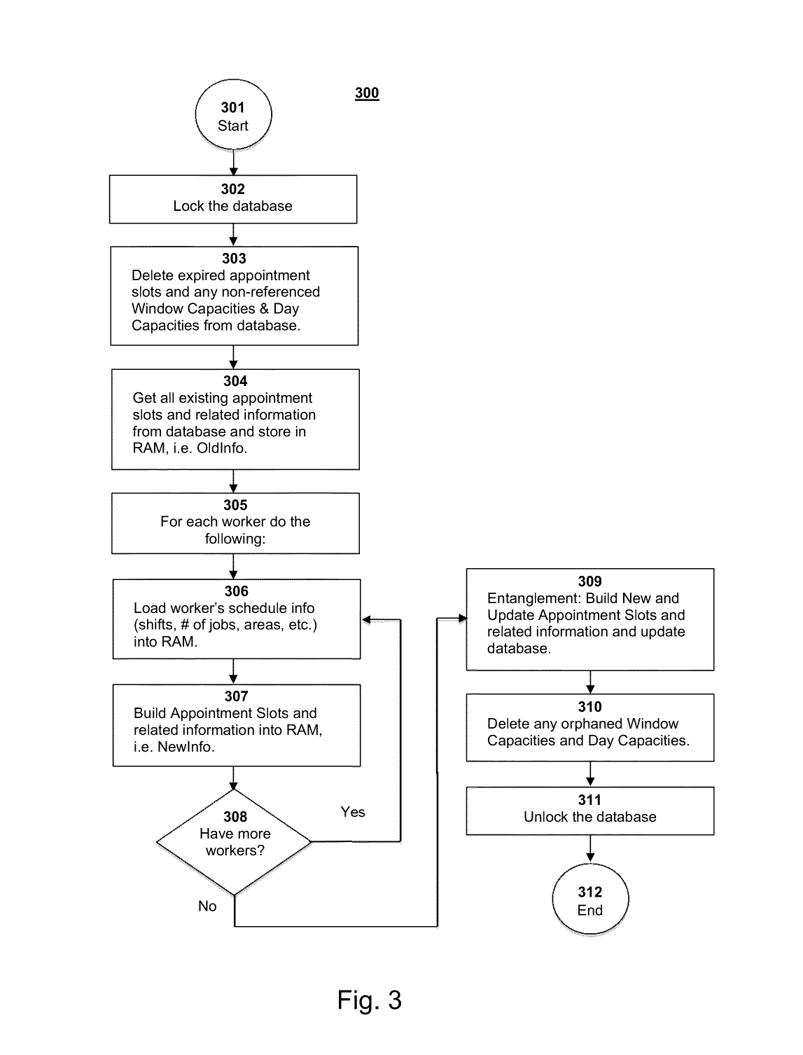

The appointment booking system creates appointment slots for each service appointment that can be offered by its workers. FIG. 3 illustrates a flow chart 300 for determining all appointments slots that can be offered for a particular day by all workers. The system starts 301 the process by locking the database 302, and would then delete expired appointment slots 303 and any non-referenced Window Capacities and Day Capacities from the database. Window Capacities and Day Capacities measure the total capacities for accommodating appointment slots per appointment window and day respectively and may be calculated in terms of minutes. The system then retrieves all old/existing appointment slots and related information from the database 105 and stores the information in RAM, as OldInfo. 304. For each worker 305 the system would then load the worker's schedule information 306, including shift information, the work areas, job types and number of jobs serviceable, and load the information into RAM. The system would then build appointment slots and related information for each worker into RAM as NewInfo 307. The system then determines if there are more workers 308. If there are more workers the system repeats steps 306 and 307. If there are no more workers the system would then build new appointment slots and update related information into the database 309. The system entangles appointment slots by reconciling existing information (OldInfo) and newly built appointment slots information (NewInfo). The system then deletes any orphaned Window Capacities and Day Capacities 310, and further unlocks the database 312 and ends the process 313.

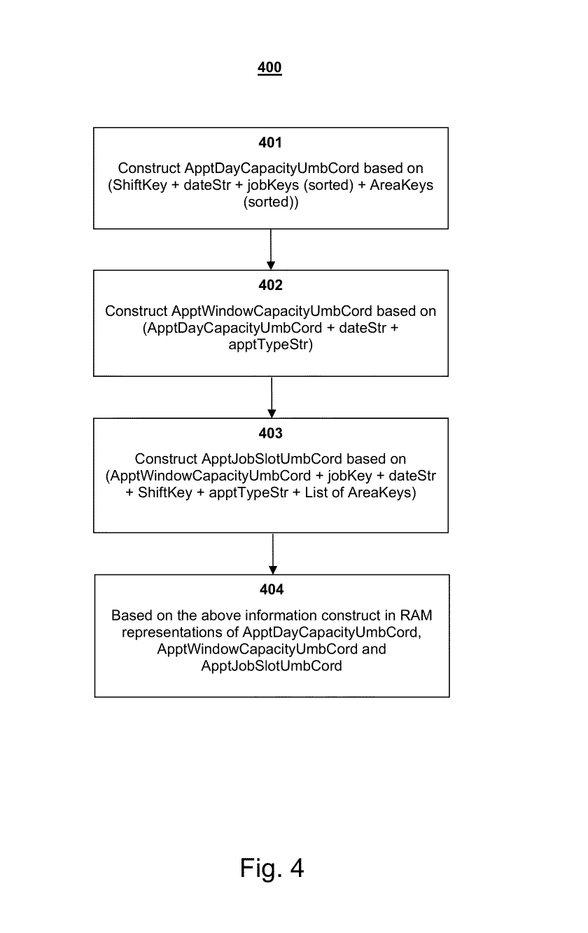

The process of building appointment slots in step 307 is illustrated by flow chart 400 in FIG. 4. Relevant information is mapped to construct a value referred to as an Umbilical Cord or simply an UmbCord. FIG. 4 shows that the system firstly constructs an ApptDayCapacityUmbCord 401 based on ShiftKey, dateStr, jobKeys and AreaKeys, which map the shift type, date, job type and area information respectively for each worker. The system then constructs an ApptWindowCapacityUmbCord 402 based on ApptDayCapacityUmbCord 401 and dateStr and apptTypeStr to map the Day Capacity, date and appointment window types for each worker respectively. The system then further constructs an ApptJobSlotUmbCord 403 based on jobKey, dateStr, ShiftKey, ApptWindowCapacityUmbCord 402, apptTypeStr and AreaKeys to map the type of jobs, date, type of shift, Window Capacity, appointment window type and area information respectively for each worker. The system then constructs representations of the ApptDayCapacityUmbCord, ApptWindowCapacityUmbCord and ApptJobSlotUmbCord into RAM 404. UmbCords are constructed when building appointment slots and are then discarded, thereby leaving no reference of them in the database.

The method of building appointment slots as illustrated by FIG. 4 effectively entangles the appointment slots offered by all workers in terms of job types, work areas, appointment window types, dates, and shifts, and enables the system to quickly and accurately determine the necessary changes to the entangled appointment slots affected when an appointment for any job type in any area during any appointment window has been booked. Those skilled in the art will appreciate that the method presented herein for building appointment slots can be applied to entangle appointment slots in terms of any number and types of attributes.

The method presented in flow chart 400 of FIG. 4 is also used to reconstruct UmbCords for any existing appointment information found in step 304. The system reconstructs the UmbCords for all appointment slots that are found to have been previously added, deleted, or changed in the database 105. The reconstructed UmbCords enable the system to reconcile and entangle existing appointment information with newly built appointments slots. If no previous appointment slots are found, newly built entangled appointment slots 307 are simply added to the database 105, and all UmbCords are discarded.

The system is capable of reconstructing the UmbCords from the database through the implementation of a particular database schema referred to as an Entangled Appointments Schema (EAS) 1000. FIG. 10 shows an ERD (Entity Relationship Diagram) for the EAS 1000. The EAS 1000 includes 5 tables that are responsible for representing all the entangled appointment slots, including: ApptDayCapacity 1010, ApptWindowCapacity 1020, ApptJobSlot 1030, ApptType 1040, and ApptJobAreaSlot 1050. The tables provide sufficient information for the system to reconstruct the UmbCords for any existing appointment information that may be found in step 304.

FIG. 10 also shows an ApptSlotBooking 1060 table that is used to record any appointment slots that may be taken, and further enables the system to subsequently make accurate changes to particular appointment slots from any cancellations or rescheduling that may occur.

Those skilled in the art will appreciate that the entangled appointment slots are governed by a time dimension provided by ApptDayCapacity and ApptWindowCapacity. The governing effects of the ApptDayCapacity and ApptWindowCapacity will be made apparent through a detailed description of a logical Capacity Table 600 presented further herein.

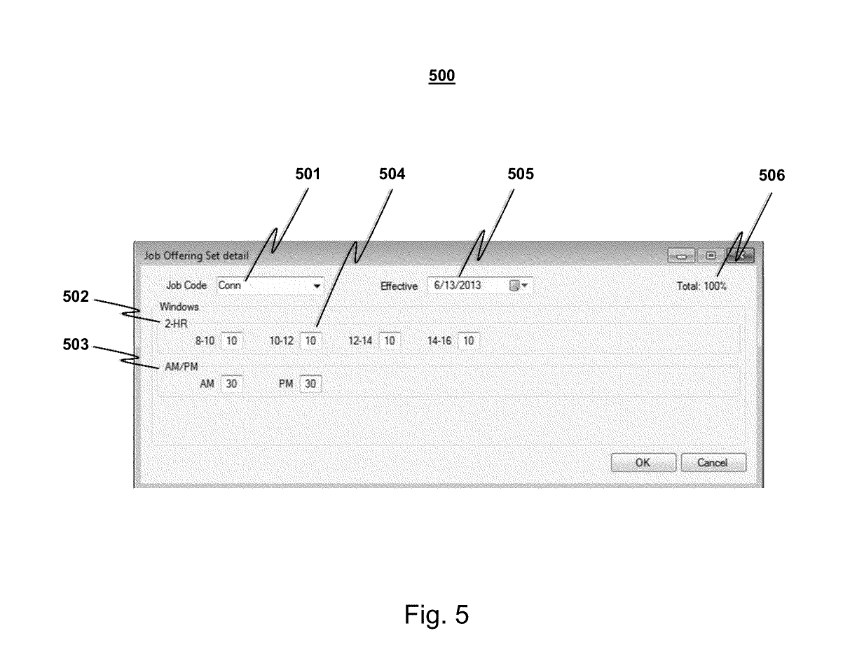

The system further enables the user to manage appointment slot offerings by controlling the amount of appointments offered for a specified job type during particular appointment windows. FIG. 5 illustrates a user interface for a Job Offering Set Tool 500 for controlling appointment offerings. The user may apply appointment offering limits to a specific job type by selecting a particular job code from a drop down menu 501. The user then specifies the amount of appointments that would be offered during each two hour appointment window 502 and/or the AM/PM appointment windows 503. The specified amounts 504 are applied as a percentage of the total available appointment offerings for a particular day, which may add to a total of 100% 506. The user may then specify the effective date 505 for the particular job offering configuration.

Appointment offering limits are applied as the system traverses each worker to build the appointment slots. The system then aggregates the appointment slot offerings. Below is exemplary code for the application of appointment offering limits:

for each day
{
for each resource or worker
{

Count how many jobs of each job type are scheduled
{

for each type of jobs, we have the number of jobs (num) to

be offered

{

Get the JobOfferings for this job type, for all

the different appointment window types

for each appointment type
{

percent = Get the percentage of the

offering for this job, for this appointment type

available slots(floating point) for this

job, this appointment type = (num * percent)

Use the UmbCord to find if an

representation or record in DB is created already

if (created)
{
// The following effectively aggregates

for workers who scheduled to do the same job type

Update the available slots (i.e.

available slots = available slots + (num * percent))

}
else
{
Create an representation or record in DB

to reflect the available slots.

}

}

}

}

}
}

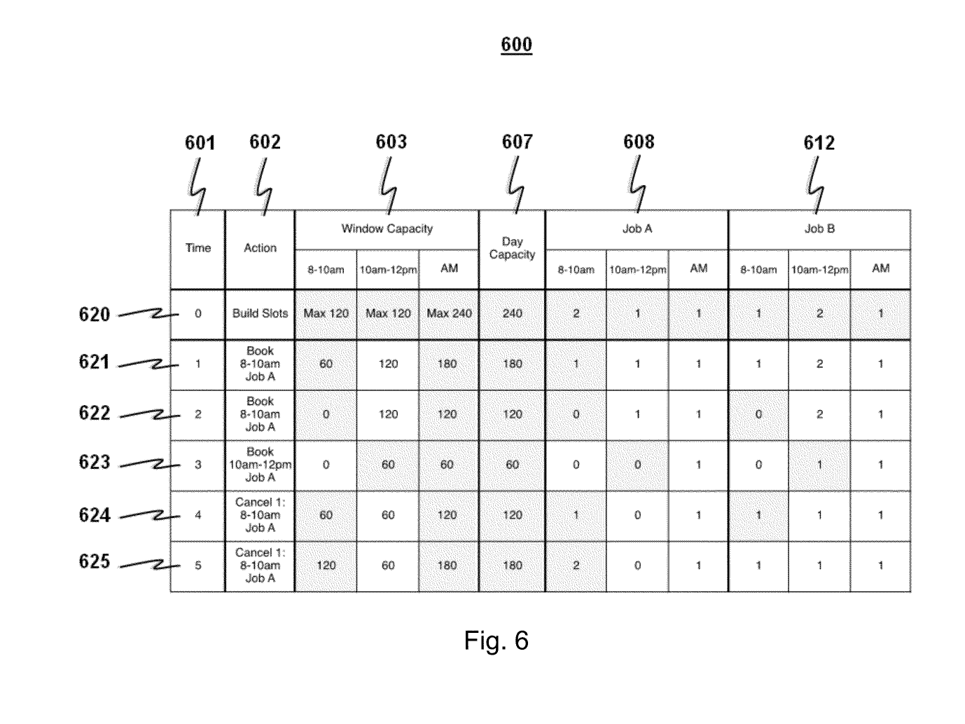

FIG. 6 shows a logical Capacity Table 600 to conceptually represent the Window Capacities, Day Capacities and appointment slots stored in the database 105. The logical Capacity Table 600 illustrates the results from building appointment slots and determining all available appointments by processing the steps described in FIG. 3. FIG. 6 shows the Window Capacity 603 and Day Capacity 607 for workers who can perform two types of jobs referred to as Job A 608 and Job B 612 where each job requires 60 minutes to complete. The Window Capacity 603 and Day Capacity 607 represent the total amount of time available to accommodate job appointments and are measured in terms of minutes.

There exists linkage hierarchy between 2-hour appointment window capacities like for “8-10 am” and “10-12 am” to the Window Capacity for “AM”. And therefore, as time is booked through e.g. “8-10 am”, then this in fact affects both Window Capacity for “8-10 am” and Window Capacity for “AM”.

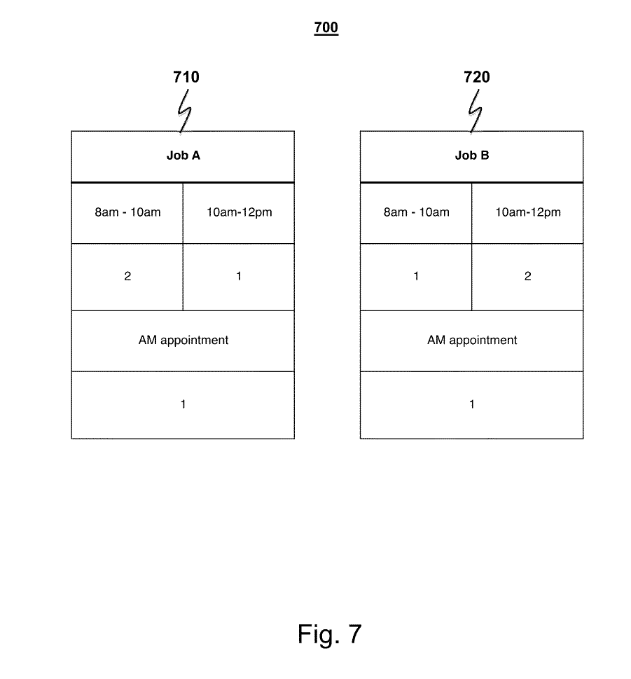

Appointment slot offerings are governed by the combination of the configurations made through the Job Offering Set Tool 500 and the Shift Detail Input Tool 200. FIG. 7 illustrates the results of job offering set configurations 700 that are applied to the logical Capacity Table 600 in FIG. 6. The job offering set configuration 700 determines that for Job A 710 there would be a limit of 2 appointments offered for “8-10 am” and 1 appointment for “10 am-12 pm” and 1 appointment for a general “AM” appointment; and also determines that for Job B 720 there would be a limit of 1 appointment offered for “8-10 am” and 2 appointments for “10 am-12 pm” and 1 appointment for a general “AM” time frame.

The logical Capacity Table 600 also shows the number of available appointment slots offered for Job A and Job B at various points in time. Capacities and appointment slot offerings change at particular points in Time 601 after particular Actions 602 take place including booking and cancelling appointments. At Time “0” 620 the system produces results in accordance to the parameters set by the job offering set configurations 700, and determines the Window Capacity 603 for “8-10 am”, and 10 am-12 pm to be 120 minutes for each appointment window, and determines the Window Capacity for “AM” and the overall Day Capacity 607 to be 240 minutes. Available appointment slots for Job A 608 at “8-10 am”, “10 am-12 pm”, and “AM”, shows 2 appointment slots, 1 appointment slot, and 1 appointment slot respectively. Available appointment slots for Job B 612 at “8-10 am”, “10 am-12 pm”, and “AM”, shows 1 appointment slot, 2 appointment slots, and 1 appointment slot respectively.

At Time “1” 621 an “8-10 am” appointment for Job A is booked, which reduces the Window Capacity for “8-10 am” appointments to 60 minutes, the Window Capacity for “AM” and the Day Capacity down to 180 minutes, and the remaining available appointment slots for Job A at “8-10 am” to 1 appointment.

At Time “2” 622 an additional “8-10 am” appointment for Job A is booked, which reduces the Window Capacity for “8-10 am” appointments to 0 minutes, the Window Capacity for “AM” and the Day Capacity down to 120 minutes, and the remaining available appointments for Job A at “8-10 am” to 0 appointment slots. The reduction of the “8-10 am” Window Capacity to 0 minutes necessitates that Job B appointment slot offerings for “8-10 am” also be reduced to 0.

At Time “3” 623 a “10 am-12 pm” appointment for Job A is booked, which reduces the Window Capacity for “10 am-12 pm” appointments to 60 minutes, the Window Capacity for “AM” and the Day Capacity down to 60 minutes, and the remaining available appointment slots for Job A at “10 am-12 pm” to 0 appointments. The reduction of the “10 am-12 pm” Window Capacity to 60 minutes necessitates that Job B appointment slot offerings for “10 am-12 pm” be reduced to 1 appointment.

At Time “4” 624 a cancellation is made for an “8-10 am” appointment for Job A, which increases the Window Capacity for “8-10 am” appointments to 60 minutes, the Window Capacity for “AM” and the Day Capacity up to 120 minutes, and the remaining available appointment slots for Job A at “8-10 am” is increased to 1 appointment slot. The increase of the “8-10 am” Window Capacity to 60 minutes enables Job B appointment slot offerings for “8-10 am” be increased to 1 appointment. The system recovers appointment slots including related entangled appointment slots from the cancellation of bookings according to a record of the original number of available appointment slots as per Time “0” 620.

At Time “5” 625 an additional cancellation is made for an “8-10 am” appointment for Job A, which increases the Window Capacity for “8-10 am” appointments to 120 minutes, the Window Capacity for “AM” and the Day Capacity up to 180 minutes, and the remaining available appointments for Job A at “8-10 am” to 2 appointment slots. The increase of the “8-10 am” Window Capacity to 120 minutes does not alter the Job B appointment slot offerings which is limited to 1 appointment for “8-10 am”, as configured by the job offering set 700.

The sequence of actions illustrated in FIG. 6 show how the system accurately and quickly makes the necessary changes to appointment slot offerings from changes to other seemingly unrelated jobs, thereby preventing overbooking.

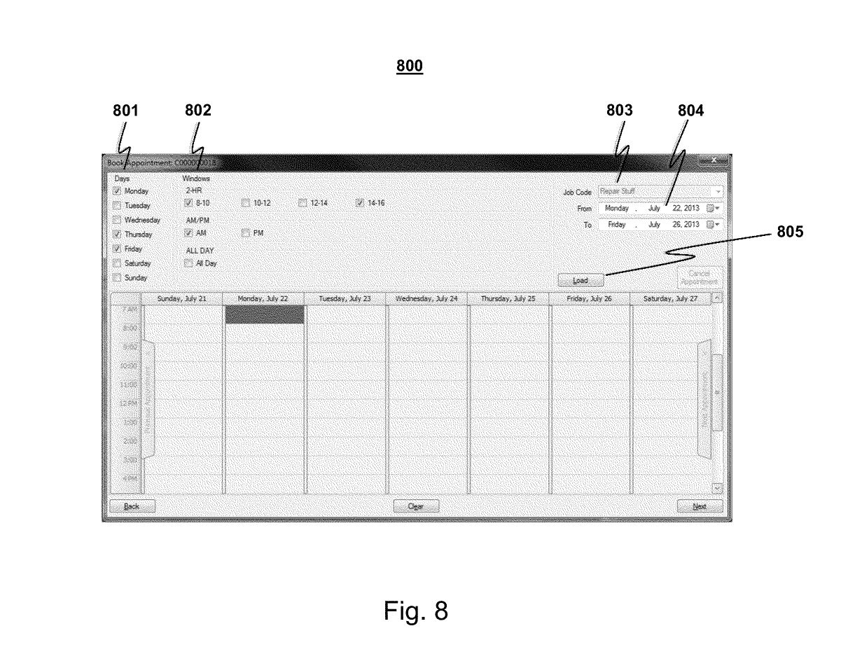

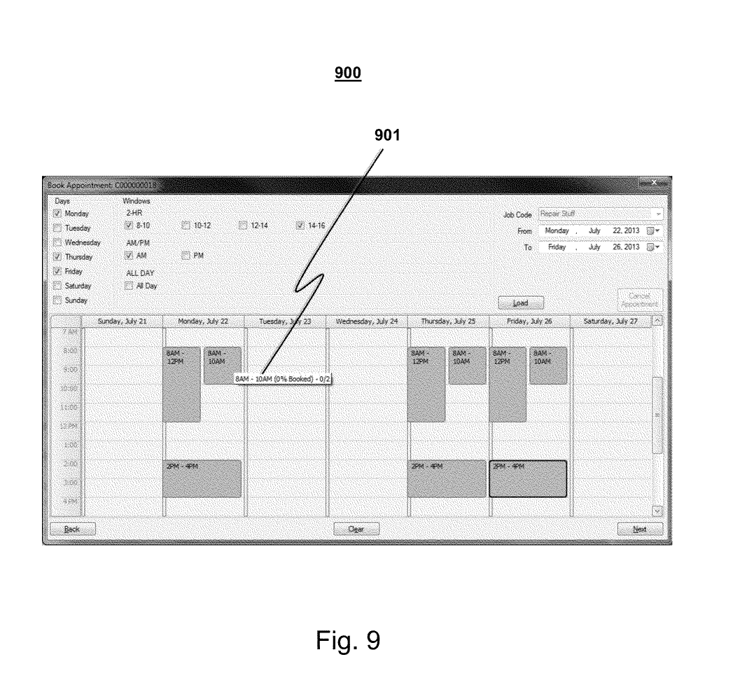

The ability for the system to simultaneously determine all available appointment slot offerings for every job type across all appointment windows further enables the user to immediately identify all appointments that satisfy a customer's multiple appointment preferences. FIG. 8 illustrates an Appointment Booking Screen 800 in which a user has entered a customer's set of preferred appointment times including the Days 801 of the week, appointment Windows 802, Job Type 803, the applicable date range 804. The user would then select Load 805 to apply the customer preferences. FIG. 9 illustrates a results screen that simultaneously shows all days and appointment windows that satisfy the customer's appointment preferences. The user may place the mouse over a particular appointment window to display the booking status 901 including the percentage of available appointments booked and the number of appointments allowed. In another embodiment the booking status may be indicated by the use of varying colour schemes and/or graphical icons. To book an appointment the user would right click on the appointment window.

The implementation of the EAS 1000 and due to the way the tables are constructed enables the use of a SQL statement to simultaneously identify all appointment slots that satisfy the customer's multiple preferences. The following is an exemplary pseudo-SQL statement that may be employed:

SELECT SUM(ajs.AvailableSlot) AvailSlots,

SUM(ajs.BookedSlot) BkSlots,
* FROM ApptJobSlot ajs, ApptJobAreaSlot ajas

WHERE ajs.JobCodeKey = ‘Job Code required’ 803
AND ajs.Date BETWEEN ‘Start date’ AND ‘End date’ 804
AND ajs.ApptTypeKey IN {list supplied by 802}
AND ajs.AreaKey = ‘Area Key’ - this is provided already via customer's
account
AND ajs.ApptJobSlotKey = ajas. ApptJobSlotKey
GROUP BY ajs.Date, ajs.ApptTypeKey

Further processing to filter out the day of week 801 requested may be done programmatically, rather than using SQL.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, or execute acts in a different order than set out in the illustrated embodiments.

The present methods, systems and articles also may be implemented as a computer program product that comprises a computer program mechanism embedded in a computer readable storage medium. For instance, the computer program product could contain program modules for installing and operating the applications described above. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and applications via the use of examples. Insofar as such examples contain one or more functions or operations, it will be understood by those skilled in the art that each function or operation within such examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers, as one or more programs running on one or more controllers (e.g., microcontrollers) as one or more programs running on one or more processors (e.g., microprocessors), as firmware, or as virtually any combination thereof, and that designing the circuitry or writing the code for the software and or firmware would be well within the skill of one of ordinary skill in the art in light of this disclosure. In addition, those skilled in the art will appreciate that the applications taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analogue communication links using TDM or IP based communication links (e.g., packet links).

At this juncture, it should be noted that although much of the foregoing description has been directed to systems and methods for resource allocation and dynamic coordination, the systems and methods disclosed herein can be similarly deployed and/or implemented in scenarios, situations, and settings far beyond the referenced scenarios. It can be readily appreciated that dynamic coordination system can be effectively employed in practically any scenario where it is required to dynamically and in real time coordinate the delivery of a finite resource. It should be further understood that any such implementation and/or deployment is within the scope of the systems and methods described herein. Additionally, it can be appreciated that implementation of the systems and methods disclosed herein enables a user to project those tasks that can and/or cannot be accomplished in a given timeframe.

It is to be understood that like numerals in the drawings represent like elements through the several figures, and that not all components and/or steps described and illustrated with reference to the figures are required for all embodiments or arrangements. It should also be understood that the embodiments and/or arrangements of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described below. It should be appreciated that according to at least one embodiment, one or more computer programs or applications that when executed perform methods of the present invention need not reside on a single computer or processor, but can be distributed in a modular fashion amongst a number of different computers or processors to implement various aspects of the systems and methods disclosed herein.

Thus, illustrative embodiments and arrangements of the present systems and methods provide a computer implemented method, computer system, and computer program product for dynamic depiction and coordination. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Further, in the methods taught herein, the various acts may be performed in a different order than that illustrated and described. Additionally, the methods can omit some acts, and/or employ additional acts.

These and other changes can be made to the present systems, methods and applications in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

### EXAMPLES

### Example 1

### Finite Resource is One or More Workers: Permutations of Jobs

There are two workers (Andy and Bob) for a utility (Telco ABC). They are scheduled to work next Monday to Friday, 8 hours, assuming no breaks. Both can work “Repair” type and “Install” type of work. Each job would take on average one hour. Both are scheduled to work 8 Repair and/or 8 Install a day. There is only one area in the entire region for telco ABC.

The Job Offering percentage and Appointment type windows are for 2-hour windows (8-10, 10-12, 12-14, 14-16), and each has 12.5% of the offering and for AM/PM windows and each has 25%. The above apply to both job types—Repair and Install.

For next Monday, the maximum that can be supported is a daily combination of the following permutation of jobs according to the following table:

| Repair | Install |
|---|---|
| 0 | 16 |
| 1 | 15 |
| 2 | 14 |
| 3 | 13 |
| . | . |
| . | . |
| . | . |
| 16 | 0 |

The Appointment Windows is overlaid on top, and the permutation looks a lot more complex

| Repair | Install |
|---|---|
| 8-10 | 8-10 |
| 0 | 1 |
| 1 | 0 |

And independently, there is a similar permutation for all other windows (10-12, 12-14, 14-16).

But for AM, they look like:

| Repair | Install |
|---|---|
| AM | AM |
| 0 | 4 |
| 1 | 3 |
| 2 | 2 |
| 3 | 1 |
| 4 | 0 |

For PM, it is the same.

However, during the database unlocked state, as some appointments are being booked, the permutations are going to be reduced (based on appointment slot relationships entangled, via visual umbilical cords, during database locked state) due to the time constraints.

So next Monday booking as such (if fully booked) may be:

| Repair | Install |
|---|---|
| 2 (8-10) | |
| 2 (10-12) | |
| | 2 (12-14) |
| 1 (14-16) | 1 (14-16) |
| 3 (AM) | 1 (AM) |
| 2 (PM) | 2 (PM) |

Or alternatively, different booking due to different times customer calls, and want different appointment types etc.

| Repair | Install |
|---|---|
| 1 (8-10) | 1 (8-10) |
| 2 (10-12) | |
| 2 (12-14) | |
| | 2 (14-16) |
| | 4 (AM) |
| 1 (PM) | 3 (PM) |

### Example 2

### Locking, Refreshing, and Adding New Information to Database

At a given time, for example, 2 AM, a system task will run to
Lock the database
Identify all stored information in the database (OldInfo) and commit OldInfo in computer memory
Collect all attributes (including workers/resources/skills availability) for the next selected time period (for example 14 days, although this can be any configurable number of days) and store in computer memory as NewInfo
From NewInfo, create a plurality of virtual umbilical cords (the NewInfo UmCords)
From OldInfo, recreate a plurality of virtual umbilical cords (the OldInfo UmCords)
Reconcile NewInfo and OldInfo (via respective UmCords).
Updating existing entangled appointment slots, deleting appointment slots (due to workers not available any more, changes of schedule, vacations etc . . . ), and creating new entangled appointment slots for new days etc . . .
All these will affect the update of the database.
Depending on the size of the database (amongst other factors) this may take minutes to hours. In the present example, the elapsed <<locked database>> time is 30 minutes. So, at about 2:30 AM, the system has finished creating all the entangled appointment slots required for the next 14 days). From the point at which the database is <<unlocked>>, there will no new entanglements. Using the quantum mechanics analogy, this is equivalent to having the two entangled particles, and now you are sending one of them to the “moon”.

At 7 AM—Customer Tom calls to book an appointment to install a new Telephone jack (Job Code/type=“Installation” e.g.), and he requests/wants a Wednesday or Thursday, 2-hr appointment, in the morning. The call taker (for example, customer service agent at the telephone company) is able to find him an appointment slot, and book such a slot, meeting Tom's requirements. This appointment for Tom is for Thursday, 8-10 AM. At the moment of the “booking” (this is equivalent to the act of measuring a state of an entangled particle), all other entangled appointment slots may be affected. In the system, the effect may be multi-fold and may effect may include that the number of appointment slots may be “reduced”, as bookings are committed.

It is important to understand that there is no entanglement being created or generated during a customer's request. However, the ancillary benefit of having entangled the <<closed>> or locked system at 2 AM are enjoyed. In other words, the system automatically affects the ‘already’ entangled appointment slots as new slot bookings are being committed.

Throughout the day, many more customers will call the customer service agent, and new appointments will be booked. As each appointment is hooked, the entangled appointment slots (the number of appointments) will or may be reduced, due to the fact that they were entangled previously during the 2 AM system task run.

Then the next day, at 2 AM, another system task will run to generate new entangled appointment slots (at least for the 14th day in this example). For the 1st to 13th days may have a lot of updates and reconciliations. This method of locking, refreshing, updating, entangling, unlocking and accepting new appointments is continually repeated over a pre-determined time frame/period.

What is claimed is:

1. A method for dynamically scheduling and optimizing appointment slots for delivery/conveyance of a finite resource, said slots being stored in a database using a computing device, the computing device having a processor, a memory, and an entanglement application stored in the memory and executable by the processor, the method comprising:
a) locking the database for a period of reconciliation and entanglement;
b) deleting expired appointment slots;
c) refreshing existing appointment slots, existing appointment slots attributes and previously saved related information (“refreshed old information”);
d) entering data relating to availability of the finite resource and at least one attribute of the finite resource over time period X (“new information”);
e) creating virtual umbilical cords for new information and recreating virtual umbilical cords for refreshed old information;
f) reconciling refreshed old information and new information via the virtual umbilical cords so formed, thereby triggering a quantum entanglement of refreshed old information (including existing appointment slots) and new information via said virtual umbilical cords (“entangled system over time period X”);
g) unlocking the database, said database then being in a state of availability for new appointment entry over time period X;
h) during time period X, receiving a new request for delivery of the finite resource wherein said request may comprise a plurality of preferences of possible dates and appointment windows;
i) replying to the request with an offer of one or more available appointment slots that satisfy at least one of plurality of preferences of possible dates and appointment windows; and
j) booking said appointment and connecting the appointment to a new appointment slot (“new appointment slot”), wherein said booking impacts and has consequences upon the entangled system over time X.

2. The method of claim 1 wherein database is subsequently locked at one of: i) any time before and ii) the expiry of time X to enter availability of the finite resource and at least one attribute of the finite resource over time period Y and for a period of reconciliation and entanglement relating to time period Y.

3. The method of claim 1 wherein finite resource is at least one of a person, a space, a tool, or equipment.

4. The method of claim 3 wherein the finite resource is a person who is a skilled worker.

5. The method of claim 1 wherein the attribute comprises specific details of slots, resources and requests.

6. The method of claim 1 wherein finite resource is a worker and attributes comprise at least one of: number workers, skill sets, task types, geographic location of tasks, time requirements, and task constraints.

7. The method of claim 1 wherein steps a) to j) are repeated at pre-determined time increments.

8. The method of claim 1 wherein building a new appointment slot comprises:
a) constructing at least one virtual umbilical cord (virtual map) relating to each finite resource and attribute thereof;
b) updating at least one virtual umbilical cord relating to each committed appointment slot and attributes thereof;
c) constructing at least one virtual umbilical cord (virtual map) relating to each available appointment slot and attributes thereof.

9. The method of claim 1 wherein the finite resource is the future availability of one or more workers, working a shift, on a day, to complete a job wherein a shift comprises one or more appointment slots.

10. The method of claim 9 wherein building a new appointment slot comprises the following steps: reconstructing virtual umbilical cords for all previously added, deleted or changed appointment slots in the database for form Reconstructed UmbCords, said Reconstructed UmbCords enabling reconcilation and entanglement of committed appointment slots (and attributes) and new appointments slots (and attributes) and wherein if no previous committed appointment slots are found, new appointment slots, so entangled are added to the database.

11. The method of claim 1 wherein inventory of appointment slots, committed slots and request for a new appointment are governed by a time dimension provided by day and time capacity tables.

12. The method of claim 1 wherein managing an inventory of appointment slots, committed slots and the new request for an appointment at appointment slot A employ the use of a Appointment Slot Booking Table within an Entangled Appointments Schema.

13. The method of claim 7 wherein umbilical cords for attributes are reconstructed according to information stored in the database according to an Entangled Appointments Schema.

14. The method of claim 13 which employs a SQL statement to access a Entangled Appointments Schema to simultaneously identify the availability of multiple appointment preferences for a set of multiple appointment preferences.

15. The method of claim 1 wherein attributes of the database of appointment slots and resources and committed appointment slots and resources are used to identify openings in slots and resources.

16. A computer system directed by a computer program operable to dynamically schedule and optimize appointment slots for delivery/conveyance of a finite resource, said slots being stored in a database, the computer system comprising:
a software engine;
a storage device operable to store program data;
a memory operable to store a computer program;
a processor coupled to the storage device and the memory, the processor operable to execute the computer program such that the computer is directed by the computer program to schedule and optimize appointment slots for delivery/conveyance of a finite resource by performing the steps of:
a) locking the database for a period of reconciliation and entanglement;
b) deleting expired appointment slots;
c) refreshing existing appointment slots, existing appointment slots attributes and previously saved related information (“refreshed old information”);
d) entering data relating to availability of the finite resource and at least one attribute of the finite resource over time period X (“new information”);
e) creating virtual umbilical cords for new information and recreating virtual umbilical cords for refreshed old information;
f) reconciling refreshed old information and new information via the virtual umbilical cords so formed, thereby triggering a quantum entanglement of refreshed old information (including existing appointment slots) and new information via said virtual umbilical cords (“entangled system over time period X”);
g) unlocking the database, said database then being in a state of availability for new appointment entry over time period X;
h) during time period X, receiving a new request for delivery of the finite resource wherein said request may comprise a plurality of preferences of possible dates and appointment windows;
i) replying to the request with an offer of one or more available appointment slots that satisfy at least one of plurality of preferences of possible dates and appointment windows; and
j) booking said appointment and connecting the appointment to a new appointment slot (“new appointment slot”), wherein said booking impacts and has consequences upon the entangled system over time X.

17. The system of claim 16 wherein finite resource is at least one of a person, a space, a tool, or equipment.

18. The system of claim 16 wherein the finite resource is a person who is a skilled worker.

19. The system of claim 16 wherein the attribute comprises specific details of slots, resources and requests.

20. The system of claim 16 wherein finite resource is a worker and attributes comprise at least one of: number workers, skill sets, task types, geographic location of tasks, time requirements, and task constraints.

21. The system of claim 16 comprising a graphical user interface tool providing the means to add, remove, and/or configure appointment slots.

22. The system of claim 17 comprising a graphical user interface tool providing the means to add, remove, and/or configure attribute details.

23. The system of claim 16 wherein database is subsequently locked at one of: i) any time before and ii) at the expiry of time X to enter availability of the finite resource and at least one attribute of the finite resource over time period Y and for a period of reconciliation and entanglement relating to time period Y.

24. A non-transitory computer-readable medium having stored thereon computer-readable instructions operable to dynamically schedule and optimize appointment slots for delivery/conveyance of a finite resource, said slots being stored in a database, such that when said instructions are executed by a computing device, it causes the computing device to:
a) lock the database for a period of reconciliation and entanglement;
b) delete expired appointment slots;
c) refresh existing appointment slots, existing appointment slots attributes and previously saved related information (“refreshed old information”);
d) enter data relating to availability of the finite resource and at least one attribute of the finite resource over time period X (“new information”);
e) create virtual umbilical cords for new information and recreate virtual umbilical cords for refreshed old information;
f) reconcile refreshed old information and new information via the virtual umbilical cords so formed, thereby triggering a quantum entanglement of refreshed old information (including existing appointment slots) and new information via said virtual umbilical cords (“entangled system over time period X”);
g) unlock the database, said database then being in a state of availability for new appointment entry over time period X;
h) during time period X, receive a new request for delivery of the finite resource wherein said request may comprise a plurality of preferences of possible dates and appointment windows;
i) reply to the request with an offer of one or more available appointment slots that satisfy at least one of plurality of preferences of possible dates and appointment windows; and
j) book said appointment (the booking) and connect the appointment to a new appointment slot (“new appointment slot”), wherein the booking impacts and has consequences upon the entangled system over time X.
